(19) United States
(12) Patent Application Publication
(10) Pub. No.: US 2006/0133282 A1
(43) Pub. Date: Jun. 22, 2006

(54) Systems and methods for multipath routing

(75) Inventor: Jesuraj Ramasamy, Westford, MA (US)

Correspondence Address: CHRISTOPHER & WEISBERG, P.A., 200 EAST LAS OLAS BOULEVARD, SUITE 2040, FORT LAUDERDALE, FL, 33301, US

(73) Assignee: Nortel Networks Limited

(21) Appl. No.: 11/238,746

(22) Filed: Sep. 29, 2005

Related U.S. Application Data
(60) Provisional application No. 60/638,040, filed on Dec. 21, 2004.

(51) Int. Cl. H04J 3/14; H04L 12/26

(52) U.S. Cl. 370/238

(57) ABSTRACT

A method and system for directing data packets from an origin node to a destination node in a multipath communication network having a plurality of nodes, where each node is connected to at least one other node by links. The apparatus includes a processor for obtaining cost information relating to each link in the network and for determining the least-cost route between the origin node and the destination node based on the cost information relating to each link. The processor establishes a cost margin representing a range of costs above the cost of the least cost route and identifies one or more alternate routes. A data storage device stores the cost information, and a network interface selectively routes the data packets through one or more of the least cost route and the one or more alternate routes falling within the established cost margin thus balancing the network load and providing alternate data paths in case the least-cost path is unavailable.

### CROSS-REFERENCE TO RELATED APPLICATIONS

This application is based on and claims priority to U.S. Provisional Patent Application No. 60/638,040, entitled SYSTEMS AND METHODS FOR MULTIPATH ROUTING, filed Dec. 21, 2004, the entire contents of which is incorporated herein by reference.

### STATEMENT REGARDING FEDERALLY SPONSORED RESEARCH OR DEVELOPMENT

n/a

### BACKGROUND OF THE INVENTION

1. Statement of the Technical Field

The present invention relates to the field of networking communications and more particularly to a method and system for using multiple paths to routing packets in a multipath communication network.

2. Description of the Related Art

As will be apparent to one of ordinary skill in the art, communication networks include a number of network devices or nodes, which are connected via links or communication paths. One well known type of communication network is a packet network. A device for managing the flow of packets in a network is commonly known as a router. Routing is the act of moving information across a network from a source node to a destination node. Along the way, at least one intermediate node is typically encountered.

Routing and routing protocols involve two basic activities: determining optimal routing paths and transporting information groups, i.e. packets, through a network. Routing protocols typically use metrics to evaluate what path will be the best for a packet to travel. A metric is a standard of measurement, such as path bandwidth, that is used by routing algorithms to determine the optimal path to a destination. To aid the process of path determination, routing algorithms initialize and maintain routing tables, which contain route information. Route information varies depending on the routing algorithm used.

Routing algorithms fill routing tables with a variety of information. Destination/next hop associations tell a router that a particular destination can be reached optimally by sending the packet to a particular router representing the “next hop” on the way to the final destination. When a router receives an incoming packet, it checks the destination address and attempts to associate this address with a next hop.

There are two types of routing algorithms: static and dynamic. Static routing algorithms are table mappings that are established by the network administrator before routing. These mappings do not change unless the network administrator alters them. Static routing allows routing tables in specific routers to be set up in a static manner so network routes for packets are set. If a router on the route malfunctions the destination may become unreachable. Algorithms that use static routes are simple to design and work well in environments where network traffic is relatively predictable and where network design is relatively simple. Because static routing systems cannot react to network changes, they are considered unsuitable for today's large, constantly changing networks.

More and more routing algorithms used by routers adjust to changing network circumstances by analyzing incoming routing update messages or detecting that expected routing update messages have not been received. These algorithms are known as dynamic routing algorithms. Given that the links or paths in a packet network are often transient, routers typically determine their respective routes for forwarding traffic to a destination node on a dynamic basis, which is known as dynamic routing. If the message or lack of an expected message indicates that a network change has occurred, routing software recalculates routes and sends out new routing update messages. These messages prompt routers to rerun their algorithms and change their routing tables accordingly.

Dynamic routing allows routing tables in routers to change as the possible routes change. There are two general classes of dynamic protocols, Interior Gateway Protocols (IGP) and Exterior Gateway Protocols (EGP). An IGP describes systems that can choose their own routing protocol. An EGP is used between routers of different systems. One well known IGP protocol for dynamic routing is known as Routing Information Protocol (RIP). RIP obtains routing information for all possible routes in a network. RIP periodically broadcasts its routing table to neighboring routers. It sends requests to other routers for their routing tables. As each router sends its routing tables, routes are calculated. However, networks utilizing RIP require a long time to stabilize after a router or a link fails and requires a great deal of bandwidth due to constant broadcasting of messages.

Another popular dynamic routing protocol is known as “Open Shortest Path First” (OSPF), which is defined in the Internet Engineering Task Force (IETF) standard RFC 2328 standard, incorporated herein by reference. According to this protocol, the lowest cost route is always chosen, wherein a metric used is a cost/weight for the path. For example, the cost of a route can be based on the additive costs of the intermediate links between the source and destination nodes. As used herein, “cost” refers to a weight given to the link or a total weight of a plurality of links and does not necessary mean a true economic cost. This approach does not, therefore, make use of other available routes. Intermediate System-to-Intermediate System (IS-IS) is another routing protocol developed by the International Organization of Standardization (ISO). It is a link-state protocol where routers exchange routing information based on a single metric to determine network topology.

A way to improve upon the OSPF routing protocol is to use an “Equal Cost Multi Path” (ECMP) routing protocol. Instead of simply choosing the lowest cost route, the ECMP routing protocol allows multiple routes having identical costs to be utilized. Thus, traffic to a certain destination can be shared among different paths having the same cost. This serves to protect routers against high traffic loads by distributing the load to other equally loaded nodes. ECMP, therefore, can be used for load balancing or fast failover, i.e. redundancy, in forwarding the packets to their destination node.

There are, however, many drawbacks associated with a straightforward ECMP route calculation. First, identifying equal cost routes involves significant processing and memory requirements in the router, as well as overhead and human intervention to determine the appropriate cost of all node-to-node paths. Therefore, the provisioning of a network for ECMP is a time-consuming and expensive process, particularly for larger communication networks. One reason is that, depending upon the particular network, optimizing routes for one node may preclude optimization for another. A true ECMP routing protocol is therefore often only partially attainable. Further, if a link becomes inoperative or other changes occur in the network, the benefits of ECMP are likely to be lost. Thus, another time consuming and expensive re-configuration will be needed.

Therefore, what is needed is an improved system and method for routing packets through a multi path communication network that incorporates some of the beneficial features of OSPF and ECMP but is not restricted by the rigid requirements and conditions set forth in calculating the ECMP paths.

### SUMMARY OF THE INVENTION

The invention describes a system and method that advantageously provides a routing protocol for routing data in a multiple path communication network.

According to one aspect, the present invention provides a method for establishing a routing protocol in a multipath communication network. The communication network includes a plurality of nodes, where each node is connected to at least one other node by links. The inventive method identifies all possible routes from a source node to a destination node and determines a cost of each route. The method determines a least-cost route between the source node and the destination node, and establishes a cost margin, where the cost margin represents a range of costs above the cost of the least cost route. Finally, one or more alternate routes are identified, where the alternate routes fall within the established cost margin.

According to another aspect, the present invention provides an apparatus for directing data packets from an origin node to a destination node in a multipath communication network. The network includes a plurality of nodes, where each node is connected to at least one other node by links. The apparatus includes a processor for obtaining cost information relating to each link in the network and for determining the least-cost route between the origin node and the destination node based on the cost information relating to each link. The processor establishes a cost margin representing a range of costs above the cost of the least cost route and identifies one or more alternate routes. The apparatus includes a data storage device for storing the cost information and the identity of the one or more alternate routes, and a network interface for selectively routing the data packets through one or more of the least cost route and the one or more alternate routes falling within the established cost margin.

According to yet another aspect, the present invention provides a storage medium storing a computer program which when executed by a processing unit performs a method for establishing a routing protocol in a multipath communication network, in which a cost margin, or range, is established and alternate cost paths falling within the cost margin are identified. The communication network includes a plurality of nodes, where each node is connected to at least one other node by links. The method identifies all possible routes from a source node to a destination node and determines a cost of each route. The method determines a least-cost route between the source node and the destination node, and establishes a cost margin, where the cost margin represents a range of costs above the cost of the least cost route. Finally, one or more alternate routes are identified, and data packets may be routed through one or more of these alternate routes, thus providing redundancy in case of system failure or for load balancing purposes.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a block diagram of a multiservice network incorporating the present invention;

FIG. 2 is a block diagram of a communication network in accordance with an embodiment of the present invention, illustrating multiple equal cost paths;

FIG. 3 is a schematic diagram of a router in accordance with an embodiment of the present invention;

FIG. 4 is a is a block diagram of a communication network in accordance with an embodiment of the present invention, illustrating an optimal cost route;

FIG. 5 is a flowchart illustrating an embodiment of the present invention; and

FIG. 6 is a flowchart illustrating an alternate embodiment of the present invention.

### DETAILED DESCRIPTION OF THE PREFERRED EMBODIMENTS

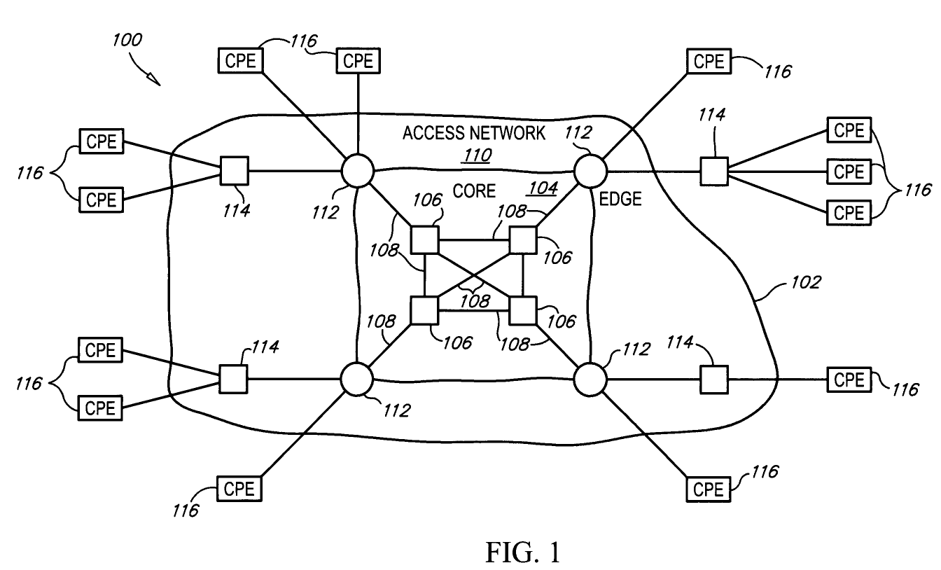

Referring now to the drawing figures in which like reference designators refer to like elements, there is shown in FIG. 1, a system constructed in accordance with the principles of the present invention and designated generally as “100”. System 100 includes an exemplary multiservice network 102 having a core network 104 that includes a plurality of core nodes 106, i.e. service provider backbone or provider core nodes, interconnected with core links 108. An access network 110 that includes a plurality of edge nodes 112, i.e. service provider edge nodes, provide access to the core network 104, through links 108 for a plurality of access nodes 114 and/or for a plurality of customer premise edge (CPE) nodes 116.

The CPE nodes 116 originate user connections, such as, but not limited to, Asynchronous Transfer Mode (ATM), Frame Relay (FR), voice or Multiprotocol Label Switching (MPLS) service requests. The access nodes 114 optionally lie between the CPEs 24 and the edge nodes 20. The access nodes 114 do not perform aggregation, i.e. individual user connections are all visible. The access nodes 114 run the service protocols (e.g. ATM, P-NNI, FR routing) and generally use single-level bandwidth management.

The edge nodes 1 12, also known as edge switches or edge routers, perform the interworking function/adaptation between the access network 1 10 and the core network 104. The edge nodes fully participate in the access network 1 10 similar to the access nodes 114 discussed above and fully participate in the core network 104 transport. Edge nodes 112 also perform the aggregation of access/user connections into transport tunnels across core network 104.

The core nodes 106 (also called core routers or MPLS core routers) have no visibility of individual user connections or applications, i.e. they are pure IP/MPLS routers. Core nodes 106 are connected to edge nodes 112 and also connected among themselves by the core links 108 an perform single-level bandwidth management, for example, Transport Bandwidth Management, which manages the bandwidth of the underlying physical links between the various transport tunnels. The core nodes 106 and edge nodes 112 participate in the core routing and maintain the same core topology database.

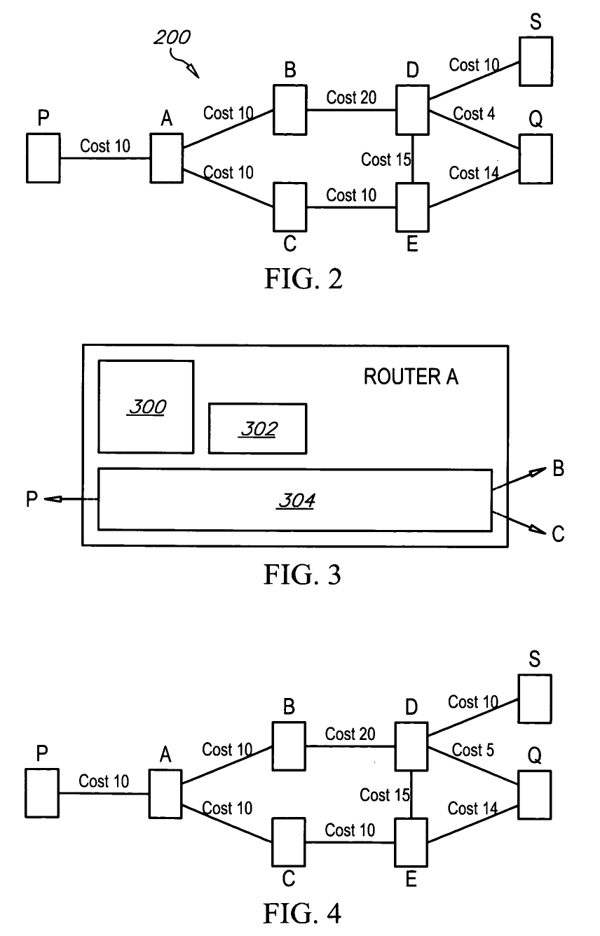

In accordance with an embodiment of the invention, there is provided a router and method of operating same, which facilitates routing in a multiple path network while reducing the configuration and management overhead associated with cost assignment. Specifically, FIG. 2 shows a communication network 200 that includes nodes P, A, B, C, D, E, S and Q. According to an embodiment of the invention, the network is a multiservice IP network where node P is a CPE node, node A is an edge node, nodes B and C are core nodes, nodes D and E are edge nodes, and nodes S and Q are CPE nodes. One of ordinary skill in the art will appreciate that the number and types of nodes shown in FIGS. 1 and 2 are merely for purposes of illustration and are not intended to limit the broader inventions set out in the Summary and Claims sections.

In the example depicted in FIG. 2, edge node A, is a router, which may be part of, but is not limited to, the Nortel Network MPE 9000 family of routers. Although the term “router” is used herein to refer to the network element used to transport data and/or routing information within and between nodes, it is readily understood by one of ordinary skill in the art that the present invention is not limited to such. Accordingly, the term “router” as used herein, can refer to any switching network element, such as a switch, router or any other computing device, such that the present invention is not limited to the use of routers in the traditional sense. Put another way, the term “router” is used merely for convenience herein and is not intended to limit the present invention to only traditional routing platforms. Router A includes suitable hardware and software to enable it to perform the functions described herein with respect to the present invention. For example, router A includes a central processing unit, volatile and non-volatile memory and storage devices, network interfaces and processors as well as other I/O interfaces to enable configuration.

Referring to FIG. 3, there is shown a schematic representation of the router A of FIG. 2, which includes a routing protocol 300, CPU 302, and forwarding module 304. As will be apparent to one of ordinary skill in the art, routing protocol 300 includes software, executed by CPU 302, for collecting information about a network. In the embodiment shown in FIG. 2, router A is to forward data packets to destination node Q. In this instance, routing protocol 300 collects information about the network via routes A-P, A-B and A-C. Using this information, routing protocol 300 determines the economic cost of the various paths in the network. The respective costs of the links in the network are shown in FIG. 2. In this example, the two best routes from router A to destination node Q are via nodes B and D (route A-B-D-Q), and also via nodes C and E (route A-C-E-Q), each at a cost of 34 units.

Thus, in the above example, routing protocol 300 searches for equal cost paths and identifies two such paths. In traditional ECMP routing protocols, each path may be used to balance the load. However, if network 200 were, instead, a large, multipath network, the cost and overhead associated with the search for all equal cost paths would be prohibitive. Further, if there is even a slight change in the cost between nodes A, B, C, D, or E, ECMP may not be possible since there are no longer multiple equal cost paths. This scenario is presented by the network shown in FIG. 4.

In FIG. 4, the cost from D to 0 has changed from 4 to 5. Thus, the cost of the A-B-D-Q route increases by 1 to 35 and the router protocol 300 in router A computes only one best path (A-C-E-Q) at a cost of 34, ignoring the A-B-D-Q path, since it is no longer equal to the A-C-E-Q path. Under traditional OSPF routing protocols, or any routing protocol used to detect a single best path to a destination, only path A-C-E-Q is recognized and used for the routing of data. ECMP routing does not apply since there are no longer multiple paths of equal cost.

The present invention relaxes the ECMP computation requirements to make other paths whose cost is within a chosen cost “band” or “margin” qualify as an “equal cost” path. Unlike a traditional OSPF routing protocol, which would simply use the best path, i.e., the least-cost route, routing protocol 300 of the present invention calculates alternate routes by modifying the “same-cost” requirement of traditional ECMP protocols to enable multipath routing notwithstanding the fact that the costs of the alternate paths are not identical. CPU 302 instructs routing protocol 300 to supply forwarding module 304 with routing data for the multiple alternate routes.

By limiting the restrictions on multipath routing parameters, the throughput and performance of router A and the network is improved since greater use is made of the network's available bandwidth. In one exemplary embodiment, a threshold margin of 10% can be used to identify alternate paths that don't necessarily qualify as “equal-cost” paths under traditional ECMP standards but are close enough in cost to the least-cost route to be used in a load-sharing routing protocol. Utilizing a cost margin also serves to remove from consideration those paths whose cost exceeds the best path by a certain chosen threshold, i.e. “cost margin”. In this way, a network operator can realize a trade off between the benefits of multipath routing and excessive costs.

Referring to FIG. 4, in an illustrative embodiment, a 10% cost margin is selected. The least-cost path from router A to destination node Q is through path A-C-E-Q, at a cost of 34. Implementing a 10% cost band would treat path A-B-D-Q as an “equal” cost path since its total cost, 35, is within 10% of the least-cost path. The 10% margin also serves to remove any routes that include the link between node D and node E, since these routes, i.e. route A-B-D-E-Q (59) and A-C-E-D-Q (40) fall outside of the 10% margin. It should be noted that the 10% margin is used only for illustrative purposes.

The network operator can select any margin, change the margin, or select no margin at all. By choosing different cost margins, the network operator can identify a variety of paths that are not equal in cost to the least-cost path, but close enough, thus leaving open the option of using these other similar-cost paths for redundancy or load-sharing purposes. Further, the overhead associated with identifying paths having costs identical to the least-cost path is greatly reduced. Alternately, if the network operator selects no margin, a traditional ECMP routing protocol can be implemented.

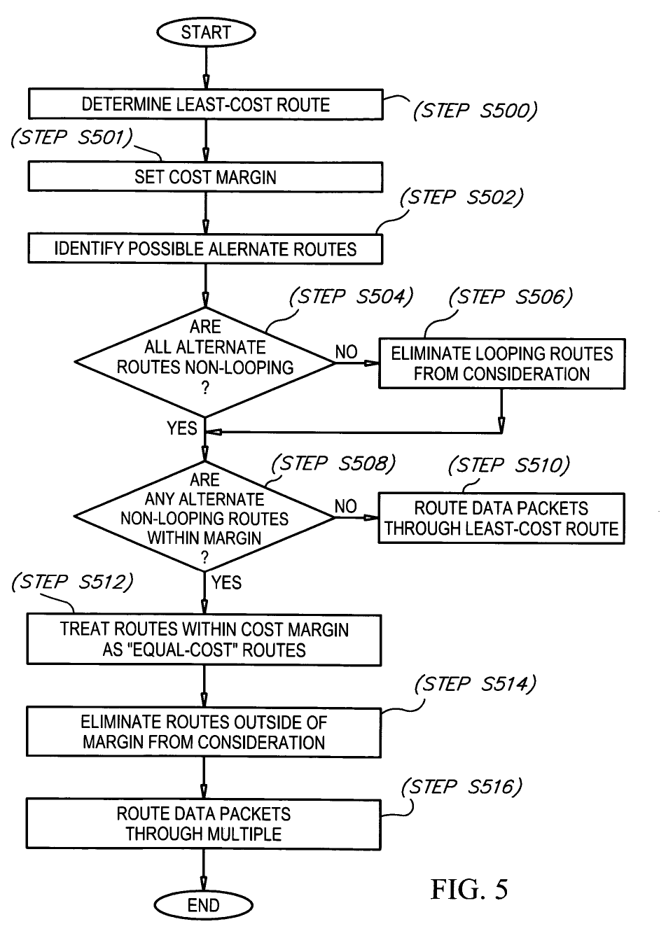

Referring to FIG. 5, a method of implementing the present invention is shown. The routing protocol 300 obtains information regarding the total cost for each route from origin node A to destination node Q in network 200. As mentioned above, the total cost of a route is the aggregate link-to-link costs in that route. Utilizing this information, routing protocol 300 determines the least-cost route from node A to node Q, via step S500. The present invention relaxes the strict requirements of typical ECMP routing protocols by accepting as “equal-cost” paths, routes that have different but similar cost totals, where “similar” is defined as costs within the selected cost range. Thus, a “cost margin” can be implemented, at step S501, which adds a pre-determined cost range to the cost of the least-cost route. The cost margin could be any percentage or absolute value of the cost of the least-cost route and can be varied depending on the requirements of the system operator.

Routing protocol 300 then ranks next-best routes by cost, thus determining possible alternate routes, via step S502. At this point, the cost margin is not yet considered. However, in an alternate embodiment, the routing protocol 300 ranks the remaining routes by cost and then eliminates any routes not within the margin. As discussed above, a typical OSPF routing protocol would simply select the least-cost route and ignore other routes, while a typical ECMP protocol would spend time and resources searching only for identical-cost routes while ignoring routes that although different in cost, are close enough not to be ignored.

Once the least-cost route and other alternate routes have been identified, protocol 300 must assure that the alternate routes are non-looping, via step S504. The present invention is particularly applicable to network protocols where it is typically not difficult to find non-looping routes. Routes that are considered looping routes are eliminated from consideration, via step S506. Routing protocol 300 then determines if the remaining non-looping routes are within the percentage margin set earlier, via step S508. If there are no non-looping routes within the cost margin, the router may direct the data packets to the destination node via the least-cost route, at step S510.

However if there are one or more non-looping routes within the established cost margin, these routes are considered “equal-cost” routes, for purposes of ECMP routing, i.e. routes to be considered equal in cost to the least-cost route, via step S512. Advantageously, routing protocol 300 of the present invention eliminates other routes that do not qualify as “equal-cost” routes, i.e., are not within the imposed cost margin, via step S514. Data packets may then be routed to not only the least-cost route, but to other routes that have qualified as “equal cost”, via step S516. In this fashion, the present invention balances the overall load on the system by sharing the data among multiple paths, provides the system operator with possible alternate routes in case of a system failure, and provides system data that might be useful at a later date when system re-design and re-configuration is needed.

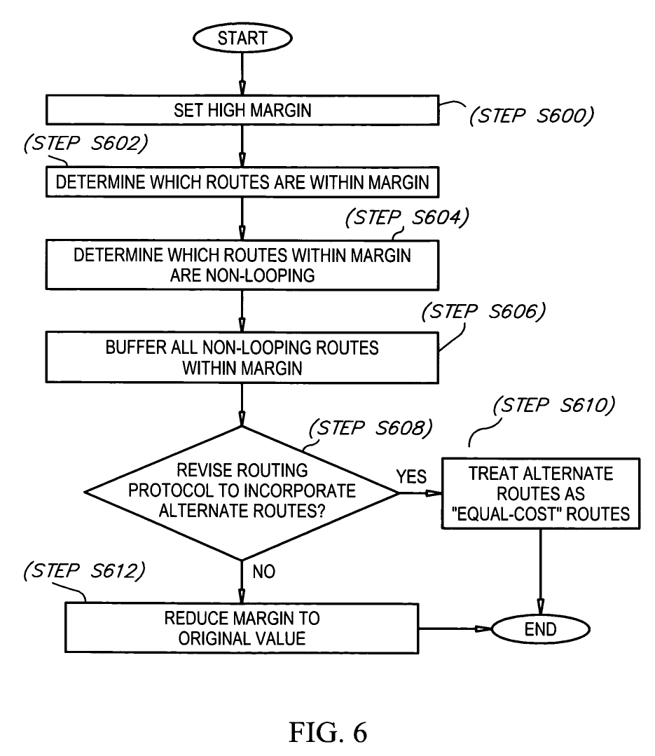

FIG. 6 is a flowchart illustrating an alternate embodiment of the present invention. In certain instances, the system operator will not actually wish to balance the system load by distributing the data packets over multiple paths, but instead, may merely wish to determine if there are any other cost-feasible paths that may be used in the future, and the relative cost of these alternate paths with respect to the least-cost path. In an exemplary embodiment, a relatively high cost margin may be chosen, for example, 25% of the least-cost route, via step S600. As described in the process shown in FIG. 5, the processor of router A determines which alternate routes fall within the cost margin, via step S602. Once looping routes have been eliminated via step S604, the resulting routes that are within the cost margin can be buffered in memory, via step S606. This information could be useful in future network designs where redundancy and load balancing considerations are at important to the network designer.

Referring once again to FIG. 6, routing protocol 300 may revise its protocol to incorporate the alternate, “equal cost” routes, via steps S608 and S610, or in the scenario discussed above, distribute the data packets only through the least-cost route while storing the information regarding the alternate routes in memory for later use. In this instance, the cost margin requirement is removed, via step S612, and the process returns to a “no-margin” ECMP or OSPF routing protocol. It should be noted that the cost margin need not be restricted to one, finite amount. For example, the network operator may set a cost margin at, for example, 25%, merely to determine if there are any other routes within this range based on the topology being considered. If there are a large number, the margin could be lowered to 10%, or if there are very few (or no) alternate routes, the margin could be raised to 50%.

Further, the initial cost margin setting, as shown in step S600 of FIG. 6 need not be relatively “high” as discussed above. The network operator may choose a relatively low cost band, obtain results, and vary the cost band to obtain additional cost data. By using a cost band, and by varying the range of the cost band, the network operator is provided with a flexible tool that is not limited to existing, restrictive cost-based routing protocols.

Routing protocol 300 thus provides the network operator with a data packet routing procedure that may be used to modify typical interior gateway protocols such as IS-IS, RIP, OSPF, and ECMP. It is applicable to and may be used to modify any cost-based routing protocol for any type of multiple path communication network. Particularly in large multipath networks, where configuration and management overhead are high due to link-cost determination, the present invention provides greater flexibility, improved reliability, and identifies a wider range of alternate routes which may be used to route data packets in the present network or to develop and improve future network designs.

The present invention can be realized in hardware, software, or a combination of hardware and software. An implementation of the method and system of the present invention can be realized in a centralized fashion in one computing system, or in a distributed fashion where different elements are spread across several interconnected computing systems. Any kind of computing system, or other apparatus adapted for carrying out the methods described herein, is suited to perform the functions described herein.

A typical combination of hardware and software could be a specialized or general purpose computer system having one or more processing elements and a computer program stored on a storage medium that, when loaded and executed, controls the computer system such that it carries out the methods described herein. The present invention can also be embedded in a computer program product, which comprises all the features enabling the implementation of the methods described herein, and which, when loaded in a computing system is able to carry out these methods. Storage medium refers to any volatile or non-volatile storage device.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. In addition, unless mention was made above to the contrary, it should be noted that all of the accompanying drawings are not to scale. Significantly, this invention can be embodied in other specific forms without departing from the spirit or essential attributes thereof, and accordingly, reference should be had to the following claims, rather than to the foregoing specification, as indicating the scope of the invention.

I claim:

1. A method for establishing a routing protocol in a multipath communication network having a plurality of nodes, each node connected to at least one other node by links, the method comprising:
identifying one or more routes from a source node to a destination node;
determining a cost of each route;
determining a least-cost route between the source node and the destination ( node;
establishing a cost margin, the cost margin representing a range of costs above the cost of the least cost route; and
identifying one or more alternate routes, the alternate routes falling within the established cost margin.

2. The method of claim 1, wherein the one or more alternate routes are non-looping routes.

3. The method of claim 1, further comprising selectively routing data packets through one or more of the least cost route and the one or more alternate routes.

4. The method of claim 1, further comprising buffering the identity of the one or more alternate routes, and routing the data packets through the least cost route.

5. The method of claim 1, further comprising revising the cost margin in order to identify one or more different routes, the one or more different routes having costs falling within the revised cost margin.

6. The method of claim 1, wherein the routing protocol is an ECMP routing protocol and the cost of the one or more alternate routes within the established cost margin are considered equal to the cost of the least-cost route.

7. The method of claim 6, wherein the data packets are not routed through any routes having costs that fall outside the established cost margin.

8. The method of claim 1, wherein the cost of a route is comprised of the sum of the costs between each link in the route.

9. The method of claim 1, wherein the cost margin is established to identify at least one alternate route.

10. An apparatus for directing data packets from an origin node to a destination node in a multipath communication network having a plurality of nodes, each node connected at least one other node by links, the apparatus comprising:
a processor for obtaining cost information relating to each link in the network and for determining the least-cost route between the origin node and the destination node based on the cost information relating to each link, wherein the processor establishes a cost margin representing a range of costs above the cost of the least cost route and identifies one or more alternate routes;
a data storage device for storing the cost information and the identity of the one or more alternate routes; and
a network interface for selectively routing the data packets through one or more of the least cost route and the one or more alternate routes falling within the established cost margin.

11. The apparatus of claim 10, wherein the one or more alternate routes are non-looping routes.

12. The apparatus of claim 10, wherein the data storage device buffers the identity of the one or more alternate routes and the network interface routes the data packets through the least cost route.

13. The apparatus of claim 10, wherein the processor is adapted to revise the cost margin in order to identify one or more different routes, the cost of the one or more different routes falling within the revised cost margin.

14. The apparatus of claim 10, wherein the cost of a route is comprised of the sum of the costs between each link in the route.

15. The apparatus of claim 10, wherein the cost margin is established to identify at least one alternate route.

16. A storage medium storing a computer program which when executed by a processing unit performs a method for establishing a routing protocol in a multipath communication network having a plurality of nodes, each node connected to at least one other node by links, the method comprising:
identifying all possible routes from a source node to a destination node;
determining a cost of each route;
determining a least-cost route between the source node and the destination node;
establishing a cost margin, the cost margin representing a range of costs above the cost of the least cost route; and
identifying one or more alternate routes, the alternate routes falling within the established cost margin.

17. The storage medium of claim 16, wherein the one or more alternate routes are non-looping routes.

18. The storage medium of claim 16, wherein the data packets are selectively routed through one or more of the least cost route and the one or more alternate routes.

19. The storage medium of claim 16, wherein the storage device buffers the identity of the one or more alternate routes, and the data packets are routed through the least cost route.

20. The storage medium of claim 16, wherein the cost margin is revised in order to identify one or more different routes, the one or more different routes falling within the revised cost margin.

21. The storage medium of claim 16, wherein the routing protocol is an ECMP routing protocol and the cost of the one or more alternate routes within the established cost margin are considered equal to the cost of the least-cost route.

22. The storage medium of claim 21, wherein the data packets are not routed to any routes having costs that fall outside the established cost margin.

23. The storage medium of claim 16, wherein the cost of a route is comprised of the sum of the costs between each link in the route.

24. The storage medium of claim 16, wherein the cost margin is established to identify at least one alternate route.
